(19) United States
(12) Patent Application Publication
(10) Pub. No.: US 2004/0250294 A1
(43) Pub. Date: Dec. 9, 2004

(54) Method and apparatus for resuming reproduction of service program from point of interruption

(76) Inventor: Sunju Kim, Seoul (KR)

Correspondence Address: FINNEGAN, HENDERSON, FARABOW, GARRETT & DUNNER, LLP, 1300 I STREET, NW, WASHINGTON, DC, 20005, US

(21) Appl. No.: 10/475,343

(22) PCT Filed: Jan. 18, 2003
(86) PCT No.: PCT/KR03/00117

(30) Foreign Application Priority Data
Jan. 18, 2002 (KR) 2002-3053

(51) Int. Cl. H04N 11/04; H04N 7/16; H04N 7/12

(52) U.S. Cl. 725/135; 725/151; 725/136; 348/384.1; 725/142

(57) ABSTRACT

The present invention relates to a method and apparatus for resuming reproduction of a program from a point at which the viewing was paused.

There is provided a service program for use with an image display device, the service program being moving images, comprising the steps of: (a) detecting an event that reproducing the service program is interrupted; (b) storing identification information at a point of interruption; (c) receiving a command to resume reproduction of the service program; (d) finding the point of interruption based on the identification information stored at step (b); and (e) executing the reproduction of the service program from the point of interruption.

### BACKGROUND OF THE INVENTION

1. Field of the Invention

The present invention relates to a method and apparatus for resuming reproduction of a service program from a point at which the viewing was paused, and, more particularly, to a method and apparatus for resuming reproduction of a stored moving image program from the point of pause while the reproduction is interrupted such as due to power-off or channel change.

2. Description of the Prior Art

Recently, boosted by the rapid development of digital technologies such as digital image compression and digital modulation/demodulation, standards with respect to digital TV, e.g., a MPEG(Motion Picture Experts Group), have been rapidly made. Therefore, broadcasting system technologies adapted to provide terrestrial, satellite and cable TV are rapidly digitized based on the MPEG standards.

Digital broadcasting systems are capable of providing more enhanced videos and audios than the existing conventional analog broadcasting systems, assisted by the broadcasting system technologies such as the digital video/audio compression technologies and digital transmission technologies. The digital broadcasting systems can thus transmit more channels in a given bandwidth, and particularly, have advantages over the analog counterparts that they are directly compatible with digital communication media as well as digital storage media.

In the digital broadcasting systems, data on TV programs are transmitted in the form of transport streams after being multiplexed according to the MPEG standards. A set-top box at the receiver site receives the transport streams and subsequently de-multiplexes the transport streams so as to extract a desired program. The desired program extracted at a de-multiplexer is then decoded and divided into audio and video signals in a decoder to be transferred to an audio/video output device such as a TV set.

Recently, a personal video recorder (PVR) set-top box has been proposed. The PVR set-top box is equipped with a hard disk adapted to store digital broadcast programs therein, having currently storage capacity of tens of gigabytes which corresponds to tens of hours of video programs such as movies, sports, shows and the like. By using the hard disk, the PVR is capable of storing a broadcast program of a channel even while a viewer is watching a broadcast program of another channel. The broadcast program stored in the hard disk may be reproduced at any time that is convenient for the viewer.

FIG. 1 is a flowchart illustrating a conventional method for locating a point of pause of a stored program.

A viewer may store broadcast programs such as movies, sports, educational programs or music videos in the hard disk and may want to reproduce them at any time the viewer desires. At a moment while the viewer is watching a movie program among the material stored in the hard disk, the viewer turns off the set-top box at step S112, e.g., at a moment after 30 minutes lapse for any reason. After a certain time lapse, the viewer may turn on again the set-top box to view an interrupted program at step S114, wherein the interrupted program refers to a program among programs stored in the hard disk that the viewer interrupts reproducing at a moment while watching the program by e.g., turning off the PVR or switching over to another channel or the like. The set-top box first displays a live TV broadcast of which the channel is preset upon turning on the set-top box at step S116. The viewer may cause a menu to be listed by pressing a button on a remote controller in order to view the interrupted program at step S118. The viewer operates the remote controller to enter into a menu indexing the programs stored in the hard disk at step S120. The viewer then selects the title of the interrupted program at step S122 by operating the remote controller. Subsequently, the viewer presses a reproduction button at step S124 and then presses a fast forward (FF) button to track down the point of pause at step S126, wherein the point of pause refers to a location or a time within a stored program where the viewer interrupts or discontinues or is interrupted from the viewing of the stored program. The viewer tracks down the point of pause by scanning the fast reproduced moving images. If the viewer finds the point of pause, the viewer can view the interrupted program reproduced from the point of pause at step S128.

In the meantime, after step S110, the viewer may set a bookmark prior to turning off the set-top box, then use the bookmark in seeking the point of pause at step S124. In other words, after turning on the set-top box again, the viewer selects a menu displaying the program list which includes programs stored in the hard disk, and selects the interrupted program in the program list, then selects the bookmark which the viewer has placed by consulting a bookmark menu, and finally resumes viewing the interrupted program from the point of pause that the bookmark points to.

According to the above-described conventional methods, the viewer should first select the program list exhibiting the programs stored in the hard disk and then select the interrupted program, then views the interrupted program to locate the point of pause by fast scanning the program from the very start. This may take long time especially in the case the lapse time is long. These series of operations are very inconvenient for the viewer and even make the viewer feel bored.

Another conventional method, i.e., using the bookmark is certainly improved. This method, however, is not free from operating various buttons on the remote controller since the viewer should consult the bookmark list.

### SUMMARY OF THE INVENTION

The present invention is provided to solve the above problems.

An object of the present invention is to provide a method and apparatus for resuming reproduction of a stored service program from the point of pause while the reproduction is interrupted such as due to power-off or channel change.

According to an aspect of the present invention for achieving the above objects, there is provided a method for reproducing a service program for use with an image display device, the service program being moving images, comprising the steps of: (a) detecting an event that reproducing the service program is interrupted; (b) storing identification information at a point of interruption; (c) receiving a command to resume reproduction of the service program; (d) finding the point of interruption based on the identification information stored at step (b); and (e) executing the reproduction of the service program from the point of interruption.

According to another aspect of the present invention, there is also provided a method for reproducing a televised program for use with an image display device, comprising the steps of: (a) detecting an event that reproducing the televised program is interrupted; (b) storing identification information at a point of interruption; (c) storing the televised program from the point of interruption; (d) receiving a command to resume reproduction of an interrupted program; (e) finding the point of interruption based on the identification information stored at step (b); and f) executing reproduction of the service program from the point of interruption.

According to yet another aspect of the present invention, there is also provided an apparatus for resuming reproduction of a service program from a point of interruption of an interrupted program, the service program being a televised TV program or the service program stored in a storage device, the interrupted program being the service program that a viewer has interrupted reproducing at a moment while watching the service program, and the point of interruption being a location or a time within the service program where the viewer has interrupted the viewing of the service program, comprising: a keypad including a plurality of key buttons for inputting commands such as channel selection, power on/off, reproduction of the service program and a point-of-pause reproduction button for inputting a command to reproduce the halted program from the point of interruption; the storage device for storing a plurality of service programs; at least one memory for storing identification information of the point of pause and data on the service program; a control unit for controlling operations in connection with storing the identification information upon occurrence of an event and resuming reproduction of the interrupted program from the point of interruption based on the identification information in response to a command to resume reproduction of the service program, the event being an interruption or a termination of reproduction of the service program; and a display device for outputting audio/video signals for reproduction of the service program.

### BRIEF DESCRIPTION OF THE DRAWINGS

The above and other objects and features of the present invention will become apparent from the following description of preferred embodiments given in conjunction with the accompanying drawings, in which:

FIG. 1 is a flowchart illustrating a conventional method for locating a point of pause of a stored program;

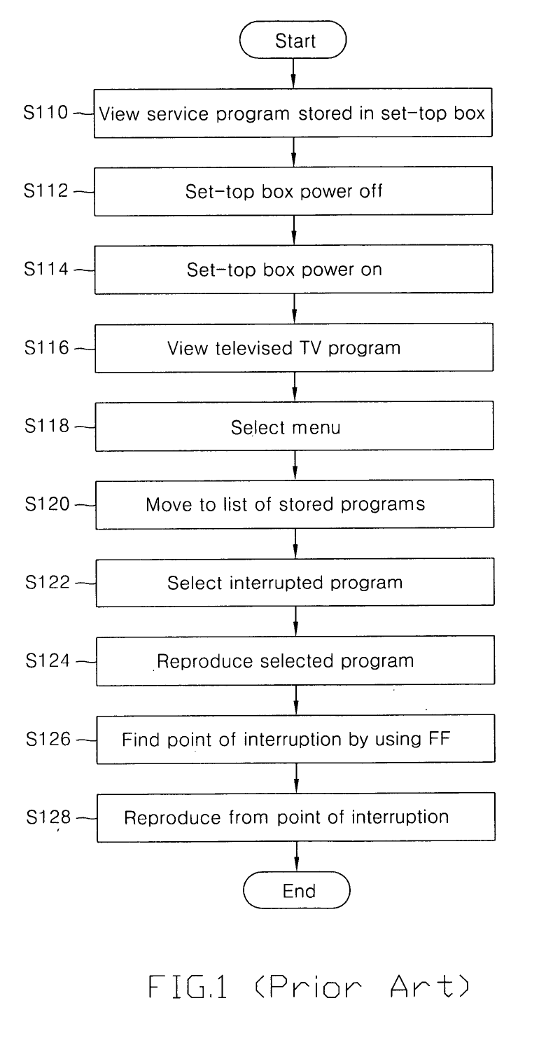

FIG. 2 is a block diagram illustrating a system for reproducing a stored program from a point of pause in accordance with the preferred embodiment of the present invention;

FIG. 3 is a flow diagram depicting a method for resuming reproduction of an interrupted service program from the point of pause in accordance with the present invention; and

FIG. 4 is a flow diagram depicting a method for resuming reproduction of an interrupted televised TV program from the point of pause in accordance with the present invention.

### DETAILED DESCRIPTION OF THE INVENTION

Hereinafter, preferred embodiments of the present invention will be explained with reference to the accompanying drawings, wherein like numerals refer to like parts throughout.

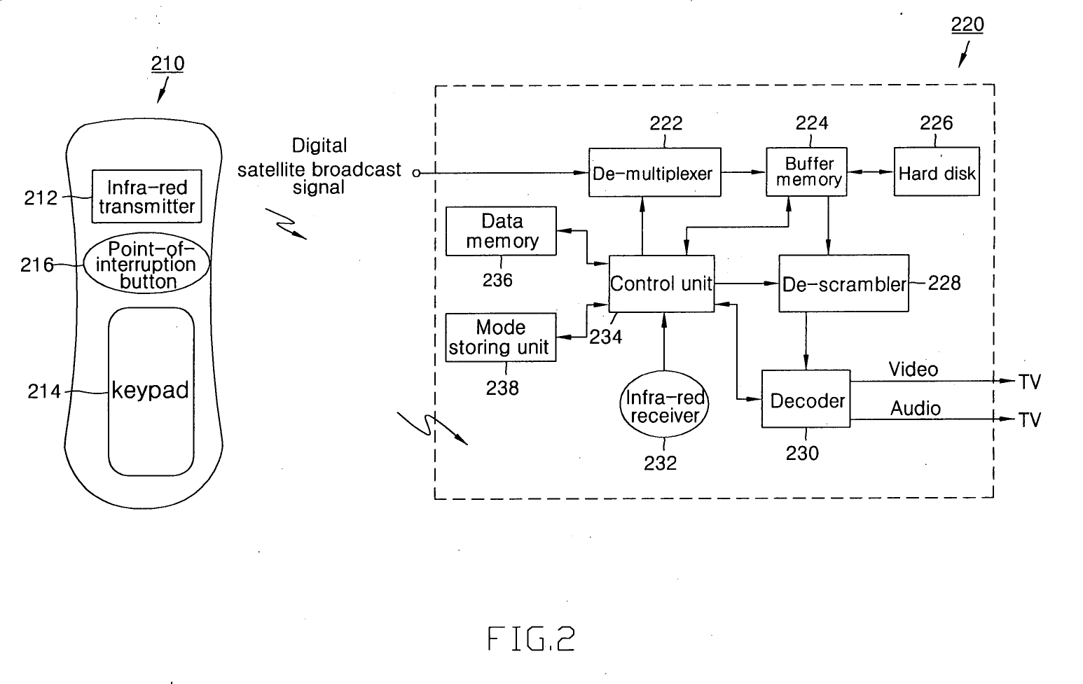

FIG. 2 is a block diagram illustrating a system for reproducing a stored program from a point of pause in accordance with the preferred embodiment of the present invention. In this particular embodiment, the stored program refers to moving images stored in a hard disk of a personal video recorder (PVR) set-top box such as movies, sports, shows and the like, and the point of pause shall mean a location or a time within a stored program where the viewer interrupts or discontinues or is interrupted from the viewing of the stored program.

In the preferred embodiment, the system comprises a remote controller 210 for transmitting instructions regarding a selection of a broadcast channel, storage of a broadcast program and reproduction of the stored program; and a PVR set-top box 220 for executing display, storage and reproduction of a broadcast program according to instructions from the remote controller 210.

Referring to FIG. 2, the remote controller 210 includes, an infra-red transmitter 212 for transmitting infra-red signals corresponding to key inputs of the remote controller 210; a keypad 214 for use in inputting instructions such as executing reproduction of the stored program; and a point-of-pause reproduction button 216 for inputting instructions in connection with reproduction from a point of pause when a viewer want to reproduce the stored program stored in the hard disk from the point where the program has been interrupted. The keypad 214 has a key button for selecting modes between e.g., a terrestrial broadcast mode and a satellite broadcast mode.

The PVR set-top box 220 includes a de-multiplexer 222 which facilitates de-multiplexing a televised program selected to a channel-selection input of the viewer and consequently extracting video/audio data streams from the selected televised program; a buffer memory 224 for temporarily storing extracted data streams; a hard disk 226 for storing the televised program; a de-scrambler 228 performing a function of so-called a “conditional access system (CAS)” which enables only an allowed viewer to view pay-per view programs; a decoder 230 for decoding the audio/video data streams received from the de-scrambler 228 by using MPEG decoding schemes such as a variable length decoding (VLD), an inverse discrete cosine transform(I-DCT) and de-quantization motion compensation(DMC); an infra-red receiver 232 for receiving the infra-red signals from the remote controller 210 and converting the received infra-red signals into electrical signals equivalent to the received infra-red signals; a control unit 234 for controlling and supervising the process from receiving the televised broadcast program through displaying the televised broadcast program, a data memory 236 for storing data indicative of the point of pause; and a mode storing unit 238 for storing operation modes of the PVR set-top box set by the control unit 234.

The de-multiplexed televised program temporarily stored in the buffer memory 224 is recorded in the hard disk 226 or provided to the de-scrambler 228 according to either a record command or a reproduction command which is originally from the viewer's input via the control unit 234.

The hard disk 226 stores therein an operating system. The hard disk 226 has a storage capacity of about maximum of 40 hours of A/D-converted TV programs or maximum of 20 hours of digital TV programs. The hard disk 226 may be divided into a program area where broadcast programs are stored and a management area where management data such as a bookmark-related information, reserved record information or a record list information, address information and directory information are stored. The broadcast programs or the management data stored in the hard disk 226 are formed as a single data file, each data file being formed with links of clusters each of which is the unit of data storage.

The de-scrambler 228 de-scrambles the scrambled program signals received from the de-multiplexer 222 or the hard disk 226 via the buffer memory 224 to rearrange the scrambled signals into normal video sequence. The de-scrambled signals de-scrambled at the de-scrambler 228 are then fed to the decoder 230 wherein the de-scrambled signals are decoded. The decoded audio/video signals generated at the decoder 230 are provided to a display device such as a TV set.

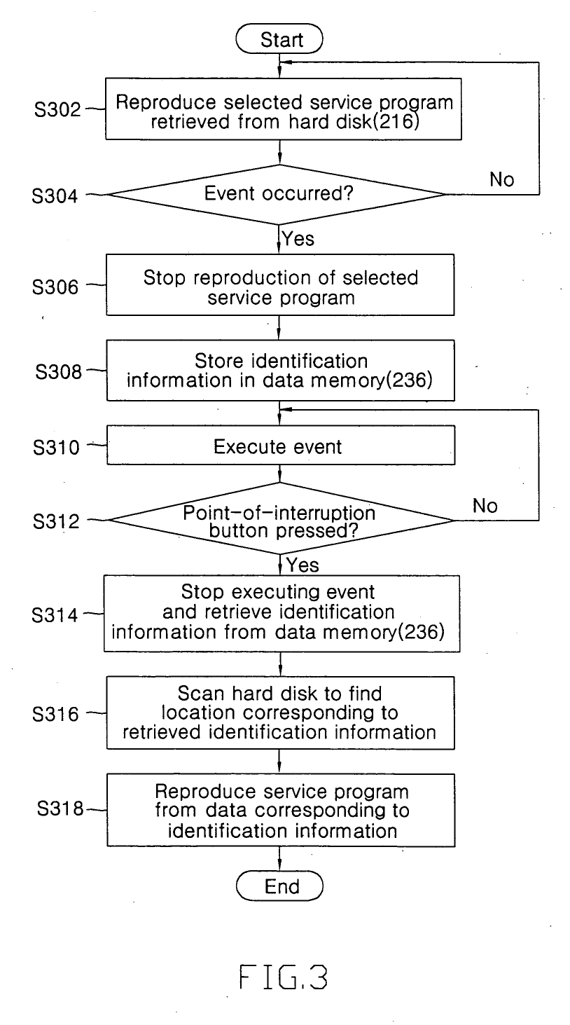

FIG. 3 is a flow diagram depicting a method for resuming reproduction of an interrupted service program from the point of pause in accordance with the present invention. Herein, the interrupted program refers to a program among programs stored in the hard disk that the viewer interrupts reproducing at a moment while watching the program by e.g., turning off the PVR or switching over to another channel or the like.

First, the viewer turns on the PVR set-top box 220 using the remote controller 210 or a power switch(not shown) The control unit 234 facilitates initializing the PVR set-top box 210 and setting an initial operating mode based on mode information stored in the mode storing unit 238. For instance, if the viewer selects a satellite mode by operating the remote controller 210, the infra-red receiver 232 accepts the signal corresponding to the viewer's selection, and then the control unit 234 stores information on the satellite mode.

Digital broadcast signal from a broadcast satellite(not shown) is received at a ground antenna, and then transferred to the PVR set-top box 220. The viewer turns on the TV set and selects a desired channel by operating the remote controller 210.

Subsequently, the remote controller 210 transmits a channel selection signal to the PVR set-top box 220 in response to the viewer's operation of the remote controller 210. The control unit 234 then controls each functional parts of the PVR set-top box 220 to have the program corresponding to the channel selection signal be displayed.

The de-multiplexer 222 de-multiplexes a digital data stream received via a tuning and channel decoding unit (not shown) under the control of the control unit 234. The de-multiplexer 222 also extracts a single program transport stream (SPTS) or a series of data stream out of the digital data stream that is multiplexed in the form of a transport stream packet. If the de-multiplexed data stream is a scrambled broadcast program, the de-scrambler 228 de-scrambles a video data stream into a normal video sequence by manipulating the video data stream in the reciprocal process of a scrambling sequence. Each data element extracted at the de-multiplexer 222 is fed to the decoder 230 wherein the data element is decoded, and finally the video and audio data stream are output to the TV set.

If the viewer selects a record function by operating the remote controller 210 in order to record a televised program, the remote controller 210 transmits a record signal corresponding to the record function from the infra-red transmitter 212. The control unit 234 of the PVR set-top box 220 receives the record signal from the remote controller 210, and then stores the data element extracted from the de-multiplexer 222 into the buffer memory 224, and subsequently transfers the data element stored in the buffer memory 224 to the hard disk 226.

Provided that satellite broadcast programs have been stored in the hard disk 226 pursuant to the above-discussed sequence and the viewer intends to reproduce any one of the satellite broadcast programs, the viewer selects a reproduction function by using the remote controller 210. Upon receiving a command corresponding to the reproduction of a program, the control unit 234 displays a program list exhibiting programs stored in the buffer memory 224. The viewer selects a program that he or she wants to reproduce, e.g., a drama program, among programs exhibited on the program list and puts a command to reproduce the drama program. In response to the command to reproduce the drama program from the remote controller 210, the control unit 234 retrieves program data corresponding to the selected drama program from the hard disk 226 and feeds the program data to the decoder 230. The program data is then decoded in the decoder 230 and output to the TV set at step 302.

In case that an event occurs that the program data corresponding to the drama program under reproduction is interrupted or interrupted for any reason, e.g., that the viewer wants to change channels in order to view a currently televised program at a moment while the viewer is viewing the drama program at step 304, the viewer selects a channel corresponding to the drama program by manipulating the remote controller 210.

Other examples of the event could be that the viewer turns off the PVR set-top box 220 or that the viewer switches over to another program, one among the programs stored in the hard disk 226 or to a channel playing another televised program.

Upon receiving a command to select a televised program from the remote controller 210, the control unit 234 interrupts reproduction of the drama program stored in the hard disk 226 at step S306. At the same time, the control unit 234 stores the identification information of the point of pause at step S308. The identification information stored in the data memory 236 indicates a memory address where the program data corresponding to the point of pause is stored.

The control unit 234 controls each functional block of the PVR set-top box 220 so as to output the currently televised program which corresponds to the channel that the viewer wants to view at step S310.

The viewer presses the point-of-pause reproduction button 216 at step S312 in order to resume viewing the interrupted program while viewing the televised program or another program stored in the hard disk 226. It is apparent that, in case that the point-of-pause reproduction button 216 is not pressed, the operations at step 310 are continuously executed.

The control unit 234, upon receiving the infra-red signal indicative of the point-of-pause reproduction, starts searching the hard disk 226 to locate the drama program corresponding to the identification information data retrieved from the data memory 236 at step S316.

The control unit 234 retrieves file name and address information of the cluster of the program file associated with the identification information, and based on these information, searches the address of the data stream corresponding to the identification information.

After locating the point of pause of the drama program, the control unit 234 retrieves the data indicative of the point of pause and stores the data in the buffer memory 224 in a prescribed format, and at the same time, retrieves the data from the buffer memory 224 prior to determining whether the retrieved data is scrambled data or de-scrambled data. If the retrieved data is the scrambled data, the de-scrambler 228 first de-scrambles the scrambled data under the control of the control unit 234 before sending the data to the decoder 230. If the retrieved data is not the scrambled data, the data is sent directly to the decoder 230. Finally, the audio/video data having been processed at the decoder 230 is sent to the TV set to be displayed.

Through the above-described procedure, the viewer can resume viewing the interrupted program directly from the point of pause without elaboration to manually searching the point of pause.

Meanwhile, also in the case the viewer turns off the set-top box 220, the control unit 234 stores the identification information about the point of pause. When the viewer presses the point-of-pause reproduction button 216 in order to resume reproduction of the interrupted program, he or she can view the interrupted program directly from the point of pause since the procedure from S314 through S318 is automatically executed in the PVR set-top box 220.

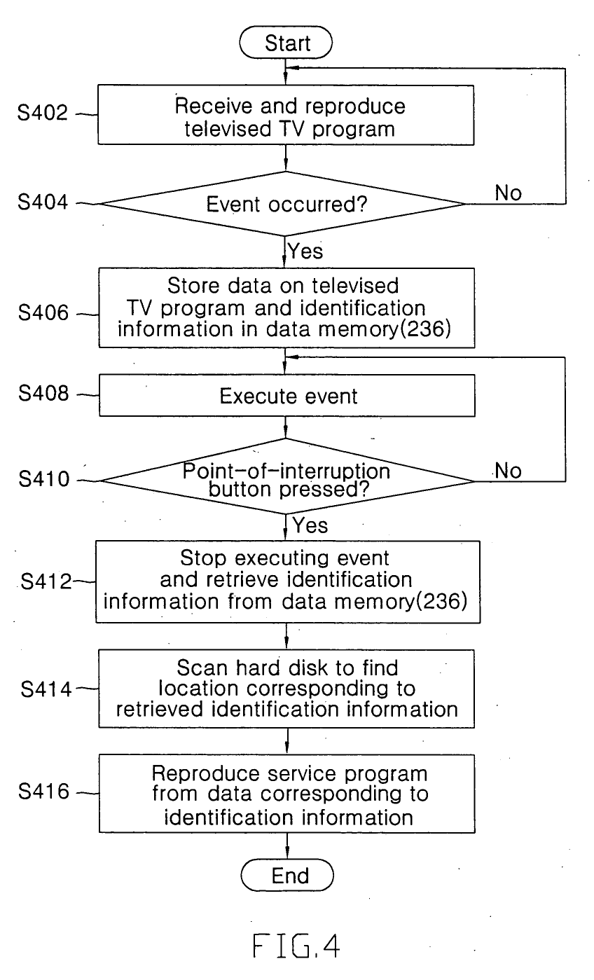

Referring now to FIG. 4, there is provided a flow diagram depicting a method for resuming reproduction of an interrupted televised TV program from the point of pause in accordance with the present invention.

When the event occurs at step S404 while the viewer is watching the televised TV program at step S402, the PVR set-top box starts to store program data on the televised TV program and the identification information of the point of pause upon detecting the occurrence of the event at step S406. The descriptions of the steps from S408 through S416 omitted since the steps are substantially identical to the steps from S310 through S318 that are described above.

While the above-discussed procedure described as resuming reproduction of the interrupted program is done by using the identification information indicative of the point of pause, a lapse time information indicating the time between the start of the stored program until the point of pause or an address of a picture of the last GOP (Graphic of Picture) in the stored program or of a start point of the stored program may be used.

In accordance with the preferred embodiment of the present invention, though the viewer changes channels in order to view the currently televised program or in order to view a program other than currently being reproduced program among the programs stored in the hard disk 226 of the PVR set-top box 220 or even turns off the PVR set-top box 220 while the viewer is watching a program stored in the hard disk 226, the PVR set-top box automatically stores the information indicative of the point of pause. Based on the information indicative of the point of pause, the PVR set-top box 220 can automatically locate the point of pause of the program that has been interrupted in case the viewer intends to resume viewing the interrupted program so that the viewer can view the interrupted program from the point of pause without elaborating to search the point of pause. This automatic locating and reproduction procedure is automatically executed simply by viewer's pressing the point-of-pause reproduction button 216.

In accordance with the present invention, the viewer can view the interrupted program directly from the point of pause without elaborating the search of the point of pause, and therefore, can save time for the search of the interrupted point.

Moreover, the viewer can view the interrupted program from the point of pause simply by pressing the point-of-pause reproduction button specially designed on the remote controller 210.

While the invention has been shown and described with respect to the preferred embodiments, it will be understood by the skilled in the art that various changes and modifications may be made without departing from the scope of the invention as defined in the following claims.

What is claimed is:

1. A method for reproducing a service program for use with an image display device, the service program being moving images, comprising the steps of:
(a) detecting an event that reproducing the service program is interrupted;
(b) storing identification information at a point of interruption;
(c) receiving a command to resume reproduction of the service program;
(d) finding the point of interruption based on the identification information stored at step (b); and
(e) executing the reproduction of the service program from the point of interruption.

2. The method as claimed in claim 1, wherein the service program is stored in a memory such as a hard disk, compact disk, and digital versatile disk.

3. The method as claimed in claim 1, wherein the service program is a televised program which is displayed and simultaneously stored in the memory.

4. The method as claimed in claim 1, wherein the event occurs when a power supply is cut off or when the viewer switches over from a channel playing a televised program to another service program, one among service programs stored in a hard disk or when the viewer switches over to another service program, one among the service programs stored in the hard disk.

5. The method as claimed in claim 1, the identification information is represented as an address corresponding to the point of interruption on the service program.

6. The method as claimed in claim 1, the identification information is represented as an address corresponding to a start point of the service program that is interrupted.

7. The method as claimed in claim 1, the identification information is represented as an address corresponding to a start point of a chapter of the service program that is interrupted.

8. The method as claimed in claim 1, the identification information is represented as time lapsed from a start point of the service program until the point of interruption.

9. A method for reproducing a televised program for use with an image display device, comprising the steps of:
(a) detecting an event that reproducing the televised program is interrupted;
(b) storing identification information at a point of interruption;
(c) storing the televised program from the point of interruption;
(d) receiving a command to resume reproduction of an interrupted program;
(e) finding the point of interruption based on the identification information stored at step (b); and
(f) executing reproduction of the service program from the point of interruption.

10. The method as claimed in claim 9, wherein the event occurs when a viewer switches over from a channel playing the televised program to the service program or to a channel displaying another televised program.

11. The method as claimed in claim 9, the identification information is represented as an address corresponding to the point of interruption on a service program.

12. The method as claimed in claim 9, the identification information and data of the televised program from the point of interruption are stored in a same storage device.

13. The method as claimed in claim 9, the identification information and data of the televised program from the point of interruption are stored in different storage devices, respectively.

14. An apparatus for resuming reproduction of a service program from a point of interruption of an interrupted program, the service program being a televised TV program or the service program stored in a storage device, the interrupted program being the service program that a viewer has interrupted reproducing at a moment while watching the service program, and the point of interruption being a location or a time within the service program where the viewer has interrupted the viewing of the service program, comprising:
a keypad including a plurality of key buttons for inputting commands such as channel selection, power on/off, reproduction of the service program and a point-of-pause reproduction button for inputting a command to reproduce the halted program from the point of interruption;
the storage device for storing a plurality of service programs;
at least one memory for storing identification information of the point of pause and data on the service program;
a control unit for controlling operations in connection with storing the identification information upon occurrence of an event and resuming reproduction of the interrupted program from the point of interruption based on the identification information in response to a command to resume reproduction of the service program, the event being an interruption or a termination of reproduction of the service program; and
a display device for outputting audio/video signals for reproduction of the service program.
